(19) United States
(12) Patent Application Publication
(10) Pub. No.: US 2005/0235533 A1
(43) Pub. Date: Oct. 27, 2005

(54) Combination keychan and informational fandeck

(76) Inventor: Gary Lemberger, Plantation, FL (US)

Correspondence Address: ROYAL W. CRAIG;A PROFESSIONAL CORPORATION, SUITE 153, 10 NORTH CALVERT STREET, BALTIMORE, MD, 21202, US

(21) Appl. No.: 11/085,834

(22) Filed: Mar. 21, 2005

Related U.S. Application Data
(60) Provisional application No. 60/554,884, filed on Mar. 19, 2004.

(51) Int. Cl. B42F 21/00

(52) U.S. Cl. 40/360

(57) ABSTRACT

A quick reference guide in the form of a combination keychain and pocket-sized informational fandeck for easy and convenient carrying on a user's person. The fandeck with dimensions of approximately ¾-1¼ inches by 2-2½ inches by 0.08 to 0.12 inches is constructed of approximately 5 coated cardboard or plastic cards stacked on top of each other. Each card has a corresponding through-bore at one end. The cards are bound together at the through-bore by a single grommet and are rotateable about the grommet. Each card is printed or engraved with text, illustrations, logos, promotional matter or the like. A single key ring is attached to the grommet.

### BACKGROUND OF THE INVENTION

1. Field of the Invention

The invention relates to a combination pocket-sized informational fandeck and keychain.

2. Description of the Background

Quick reference guides are convenient for a variety of purposes ranging from “how to” guides to map and tourist information. Quick reference guides often come in the form of small pamphlets, cards, or fandecks.

A fandeck is a deck of sturdy flat cards (i.e. cardboard, coated cardboard, laminated cardboard, plastic, etc.) bound together at one end about a single axis. This method of binding allows the cards to be “fanned” open for quick and easy reference without altering the order of the cards. Examples of fandecks include paint color fandecks (available through most paint manufacturers) or Fandex™ Guides (available through Workman's Publishing (www.workman.com)). Fandex™ Guides are a series of pivotally-attached cards having full color illustrations and text on a variety of topics ranging from wild birds (each card representing a particular bird) to presidents (each card representing a president). The cards of conventional fandecks are of uniform size, flat, long and thin and are oftentimes stacked to a thickness of greater than ¾ of an inch (i.e. Fandex™ Guides include about 50 cards and have dimensions of approximately 1″ by 11″ by 4″). The sturdy structure of the cards provides for greater durability over paper reference materials. While conventional fandecks are useful reference tools, they are not practical to carry around as an on-the-go quick reference tool.

There is a need for an indexed quick reference tool that promotes itself for easy and convenient carrying on a user's person at all times. Such a reference tool would allow the user instant on-the-go access to indexed information ranging from vehicle safety and first aide information to new student or employee information to area subway guides. Specifically, there is a need for a quick reference tool that is small and flat enough to be carried comfortably in a person's pocket, and attachable to a keychain/key ring (for car, apartment, dorm keys or the like) to encourage the user to carry the reference tool at all times. The foregoing can be accomplished with a miniature fandeck (i.e. approximately 2″ by 1″) with approximately 5 sturdy coated cards, having a combined thickness of approximately 0.1″. However, such a fandeck would also need to be durable and sit flat in a person's pocket without being uncomfortable or overly burdensome. An additional advantage to such a reference tool/keychain, is that it may be used as an advertising or promotional tool.

There are examples in the prior art of small children's books attached to keychains. One example of such a keychain book is “Sea Sayings: A Keychain Book” by Victoria Saxon, Mouse Works Publishing 1997, with dimension of 0.25″ by 3.25″ by 2.75″. These keychain books are typically designed as toys or for use as decorations on backpacks and the like. Small books of this sort, even though smaller than a typical book, are not conveniently and easily carried on the user's person (i.e. in a pocket). Nor are they made of sturdy coated cards to accommodate wear and tear due continuous use. Similarly, informational cards are also found attached to “keychains” (i.e. Animal Track Keychain Identification Guide (www.acornaturalists.com) with 22 cards having dimensions of 1¼″ by 4″). As with the small book keychains, these keychain guides are not designed for easy and convenient carrying on the user's person, but rather attachment to a backpack or the like.

It would be greatly advantageous to provide a combination keychain and pocket-sized informational fandeck for convenient and easy carrying on a user's person.

### SUMMARY OF THE INVENTION

It is the primary object of the present invention to provide a combination keychain and informational fandeck for use as quick reference guide in a given topic.

It is a further object of the present invention that the keychain/fandeck is pocket-sized for convenient and easy carrying on a user's person.

It is another object of the present invention that the keychain/fandeck of the present invention is printed or engraved with full-color text and illustrations.

Another object of the present invention is that the keychain/fandeck is printed or engraved with promotional illustrations and indicia.

It is yet another object of the present invention that the keychain of the present invention also be used to hold an additional pocket-sized object or tool related to the topic of the informational fandeck.

Lastly, it is an object of the present invention to provide such a quick reference combination keychain/fandeck as one object in a more comprehensive guide kit on the given topic.

According to the present invention, the above-described and other objects are accomplished by providing an informational fandeck. The fandeck includes approximately five sturdy cards, each card preferably being approximately 20-30 mm thick. The thickness may vary somewhat as a matter of design choice. Each card includes a corresponding through bore at one end. The cards are bound together at the through bore by a single grommet/eyelet such that the cards may be individually rotated about the eyelet and fanned. The fandeck is pocket-sized with closed dimensions of approximately ¾-1¼″ by 2-2½″. The length of the individual cards of fandeck may vary slightly from the top to bottom card in the deck, shorter to longer, respectively. Varying the card lengths creates a natural tab for indicating the subject of each card within the overall guide topic. The cards may be die-cut to different shapes depending upon the overall topic of the fandeck. The front and back of each card may be printed with full-color illustrations and text. Attached through the grommet/eyelet of the fandeck is a key ring or other type key chain.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is an illustration of an exemplary fandeck/keychain of the present invention with FIGS. 1a-c being front (closed), side and front (fanned) views, respectively.

FIG. 2 is an illustration of another exemplary fandeck/keychain of the present invention with FIGS. 2a-c being front (closed), side and front (fanned) views, respectively.

FIGS. 2d and 2e are front and back views, respectively, of the individual cards 102(a)-(e) of the exemplary fandeck/keychain of FIG. 2.

FIG. 3 is an illustration of the components of an exemplary guide kit, including an exemplary fandeck/keychain with a related tool (FIG. 3a), additional kit objects (FIG. 3b) and kit operational instructions (FIG. 3c).

### DETAILED DESCRIPTION OF THE PREFERRED EMBODIMENT

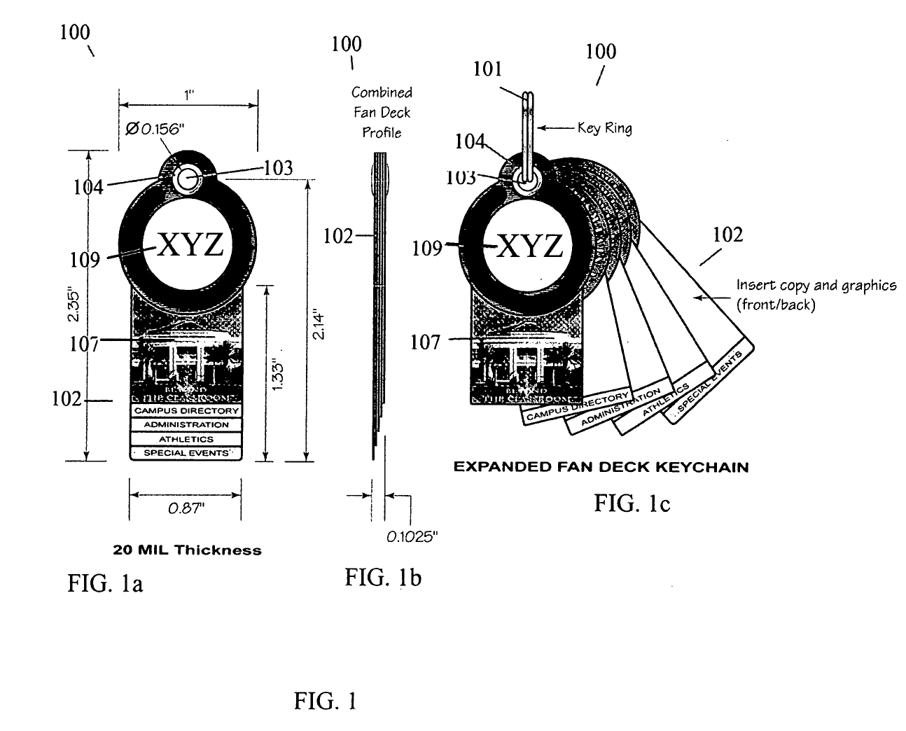

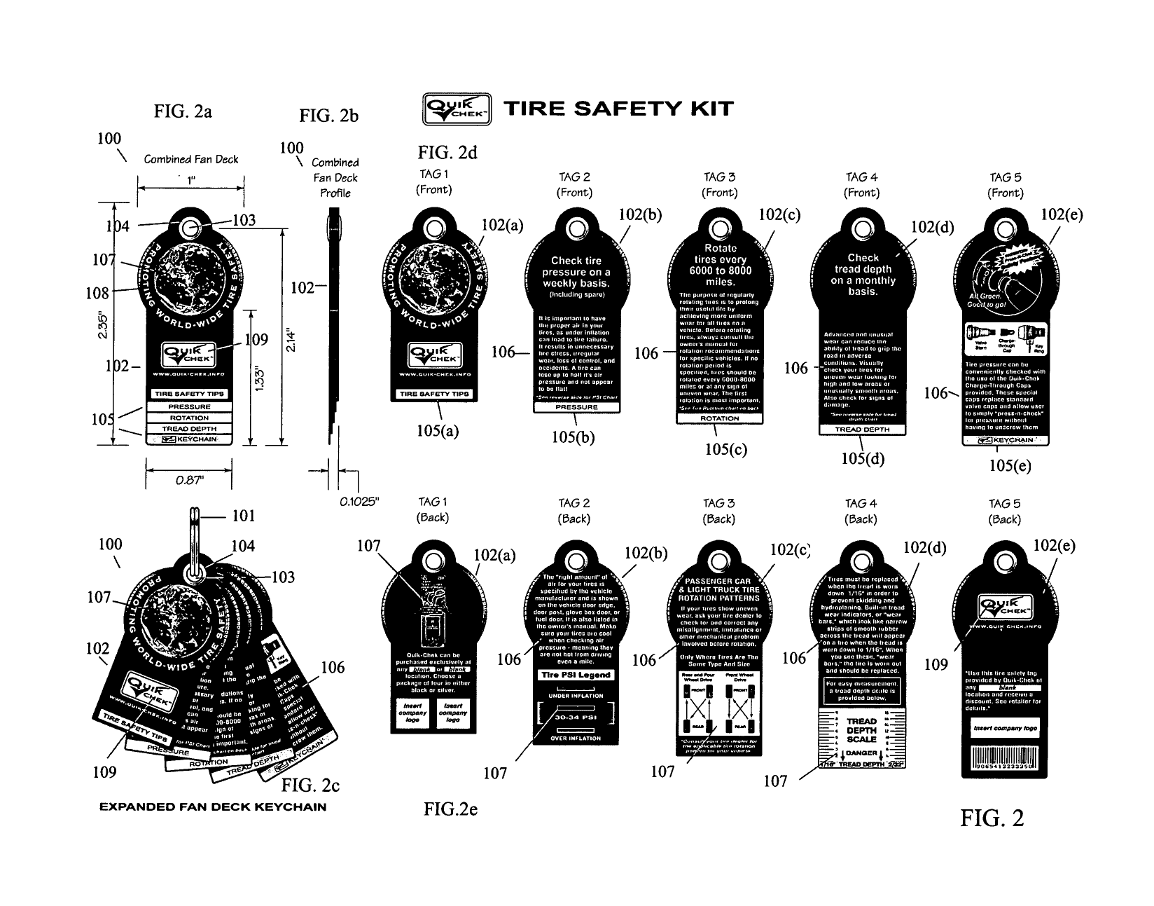

The present invention is a pocket-sized combination keychain and indexed-informational fandeck for use as a quick reference guide on a particular topic. FIGS. 1 and 2 are exemplary illustration of this combination keychain/fandeck 100 of the present invention.

Referring in combination to FIGS. 1a-c and 2a-c, the keychain/fandeck 100 includes a keychain 101 and approximately five sturdy cards 102. The cards are preferably constructed of coated or laminated cardboard or plastic because such materials are durable and are easily wiped clean. Each card 102 includes a corresponding through bore 103 at one end. The cards 102 are then bound together at the through bore 103 by a grommet 104. The depth of the grommet 104 is such that it binds each card snugly together, while still allowing the cards to be rotated individually about the grommet 104 (i.e. fanned as in FIGS. 1c and 2c).

In the preferred embodiment of the present invention the fandeck 100 has overall dimensions of approximately ¾-1¼″ by 2-2½″ with each card in the fandeck 100 being approximately 0.02″ thick. Thus, a fandeck 100 with five cards is approximately 0.1″ thick. This size fandeck 100 is particularly suited for carrying in a pocket without being too bulky or heavy. Referring in combination to FIGS. 1c and 2c-e the length of the individual cards 102(a)-(e) of the fandeck 100 may vary slightly from the top 102(a) to bottom 102(e) card in the deck 100, shorter to longer, respectively. The longest card 102(e) being approximately 2-2½″ in length. Varying the lengths of the cards 102(a)-(e) creates natural tabs 105 on the front of each card 102 (See 105(a)-(e) on FIG. 2d) for indicating the subject of each card 102 within the overall fandeck topic. The cards 102 are preferably stacked in a sequence such as, for example, the top card 102(a) being shortest, middle cards 102(b)-(d) longer, and last card 102(e) longest. However, the sequence may easily be varied as a matter of design choice. For example, the middle card 102(c) may be longest and slope to both front and back.

Each card 102 of the keychain/fandeck 100 is printed or engraved with text 106 and optional illustrations, graphics, pictures, etc 107 on both the front and back surfaces (See FIGS. 2d and 2e). Full-color is optional. Die-cut cards with varying shapes corresponding to the particular topic are also optional. For example, the topic of the exemplary fandeck/keychain of FIG. 2 is tire safety and each card 102 is die-cut to include a circular section 108 in the shape of a tire. Each keychain/fandeck 100 also may also be printed or engraved with optional promotional illustrations, logos, graphics, instructions, indicia, etc. 109, such as the XYZ for XYZ University illustrated in FIG. 1 or the Quick Chek™ illustrated in FIG. 2. The Quick Chek™ is a diagnostic tire inflation gauge, and there is great synergy in attaching the Quick Chek™ device itself to the keychain and providing accompanying instructions 109 for proper usage via the keychain/fandeck 100. The subject matter context of each individual card 102 may be indexed by a reference label printed on the respective tab 105 for quick and easy reference.

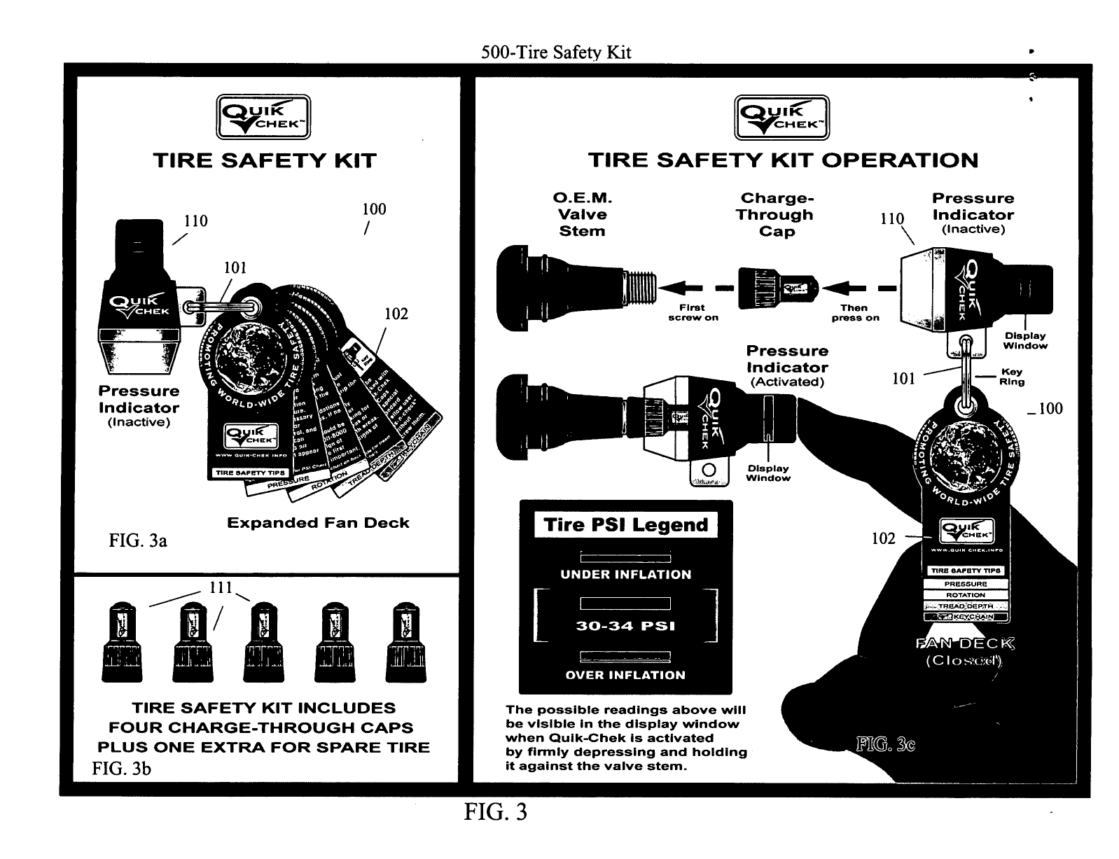

Referring to FIG. 3a, keychain 101 (i.e. key ring or the like) may be a ring, clip or quick-release chain. Each keychain/fandeck 100 may be an integral part of the keychain 101 or removably attached. In the preferred embodiment the key ring 101 is also attached to a pocket-sized object or tool 110 related to the topic of the informational fandeck 100. This concept greatly increases the marketing value of the device. For example, the topic of the exemplary keychain/fandeck 100 illustrated in FIG. 3a is “tire safety” and the optional tool 110 is a pocket-sized tire pressure indicator.

Referring in combination to FIGS. 3a-c, the keychain/fandeck 100 may be included as one object in a more comprehensive guide kit 500 on a given topic. For example, a comprehensive guide kit 500 (i.e. Tire Safety Kit 500 of FIG. 3), may include an informational keychain/fandeck 100 with an optional attached tool 110 (i.e. FIG. 3a Tire Safety Tips fandeck with pressure indicator), additional topic related objects 111 (i.e. FIG. 3b multiple Charge-through Caps), and other topic related information 112, such as detailed reference guides, books, or operational instructions (FIG. 3c).

In still other embodiments, an identification chip (“IC”) can be implanted in the keychain/fandeck 100, key ring 101, or optional object or tool 110 to provide even greater utility. For example, the (“IC”) may serve as a smartcard-type ID for college students. It is also envisioned that a global positioning system (GPS) receiver may be incorporated into the IC to allow tracking and location of the bearer. This way, if a student is missing, he/she can be quickly located by GPS tracking of his/her keychain/fandeck 100. Conversely, it can also help to find lost/misplaced keys.

User's of the pocket-sized informational fandeck of the present invention in its various forms will appreciate that this quick reference tool is easy to use and not burdensome to carry. Additionally, because this pocket-sized fandeck is formed in combination with a keychain it is convenient to carry at all or most times and will, therefore, be accessible when most needed. For example, a new student at XYZ University will using the keychain/fandeck illustrated in FIG. 1 to carry dorm keys, will find the campus directory particularly helpful during the first few weeks of school. Similarly, a driver using the keychain/fandeck illustrated in FIG. 1, will find the “PRESSURE” information card (FIGS. 2d(2) and 2e(2)) particularly helpful in the event of a low tire. Heretofore, drivers and students, respectively, would have either had to ask for assistance or to refer to bulky owner's manuals or student guides for the required information.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

1. A quick reference tool, comprising:
a keychain with key ring;
an informational fandeck formed from a plurality of cards each having a through bore at one end, all of said cards being bound together at said through bore by a grommet inserted there through and holding said cards snugly yet rotatably together, the key ring of said keychain being inserted through said grommet, said plurality of cards being different lengths and stacked successively so that at least an end portion of each card is visible, and at least one side of each of said cards bearing printed information including index information on said end portion for quick reference to said printed information thereon; and,
a key ring attached through said grommet;
whereby said quick reference tool is pocket-sized so that it may be easily and conveniently carried on a user's person.

2. The tool according to claim 1, wherein said fandeck comprises five cards, each card being approximately 0.02 inches thick, ¾-1¼ inches wide and 2-2½ inches long.

3. The tool according to claim 1, wherein each card comprises laminated cardboard.

4. The tool according to claim 1, wherein each card comprises plastic.

5. The tool according to claim 1, wherein said fandeck comprises five cards stacked in a Sequence, the top card being shortest and last card longest.

6. The tool according to claim 4, wherein each card is engraved with text.

7. The tool according to claim 1, wherein at least one of said cards contains an identification chip (“IC”).

8. The tool according to claim 7, further comprising a global positioning system (GPS) receiver in said IC to allow tracking and location of the bearer.
